(19) United States
(12) Patent Application Publication
(10) Pub. No.: US 2025/0384577 A1
(43) Pub. Date: Dec. 18, 2025

(54) METHOD FOR INTELLIGENT POSTURE DETECTION, INTELLIGENT POSTURE DETECTION APPARATUS, AND CIRCUIT SYSTEM

(71) Applicant: REALTEK SEMICONDUCTOR CORP., HSINCHU (TW)

(72) Inventors: Chih-Yuan Koh, HSINCHU (TW); SHIH-TSE CHEN, HSINCHU (TW); Chao-Hsun Yang, HSINCHU (TW)

(21) Appl. No.: 19/237,522

(22) Filed: Jun. 13, 2025

(30) Foreign Application Priority Data
Jun. 17, 2024 (TW) 113122247

(51) Int. Cl. G06T 7/73; G06V 10/44; G06V 10/764

(52) U.S. Cl. CPC G06T 7/73; G06V 10/44; G06V 10/764

(57) ABSTRACT

A method for intelligent posture detection, an intelligent posture detection apparatus, and a circuit system are provided. The circuit system is disposed in the intelligent posture detection apparatus, and the method is performed in the circuit system. In the method, the circuit system retrieves an image from an image-retrieval circuit, and operates an intelligence model by an operating circuit for determining an object window that covers an object in the image and multiple key points of the object. Next, a first correlation among a whole or part of the key points of a current posture of the object, and a second correlation between the object window and the whole or part of the key points are established. The first correlation, the second correlation, and/or geometric information of the object window can be referred to for determining whether or not the current posture of the object is poor.

### CROSS-REFERENCE TO RELATED PATENT APPLICATION

This application claims the benefit of priority to Taiwan Patent Application No. 113122247, filed on Jun. 17, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a technology of human posture detection, and more particularly to a method for intelligent posture detection that applies a vision sensing technology and an intelligence algorithm to detect a human posture, an intelligent posture detection apparatus, and a circuit system.

### BACKGROUND OF THE DISCLOSURE

A proper body posture is important for children during their skeletal development period. A poor sitting posture and a poor standing posture easily cause the bones to grow in a crooked manner, and may increase the risk of suffering from related diseases. For example, the children are often in a sitting position in daily life, and need to remain seated in class or doing homework. The recent research shows that the poor sitting posture, slouching, or hunching over may not only result in poor bone development, but also affect the children's concentration since the children cannot get enough oxygen and breath smoothly when the lung is compressed. It is a laborious task for parents or teachers to constantly check and remind children to sit properly. As such, it is necessary to develop an automated system for detecting the children's poor posture, so as to reduce burden on supervisors (i.e., the parents and the teachers).

According to some past studies, the human posture can be determined through various signals generated by a three-axis sensor or a six-axis sensor that is mounted on the back of a human body when detecting a human motion. A machine-learning classifier can be used to recognize a hunched back or an inclined sitting posture according to the signals to be processed. Alternatively, the signals collected by various wearable devices can be integrated for reconstructing three-dimensional coordinate points of each joint, and then the three-dimensional coordinate points are converted into two-dimensional features for calculating posture scores. The posture scores are used to determine the probability of a specific posture. Further, for users of mobile phones, a front lens can be used to collect images for calculating an angle of the head of the user, so as to determine whether or not the user is bowing his head to use the mobile phone.

### SUMMARY OF THE DISCLOSURE

The present disclosure relates to a method for intelligent posture detection, an intelligent posture detection apparatus, and a circuit system that provide a solution for notifying a poor posture. The method for intelligent posture detection can be implemented in the intelligent posture detection apparatus through software, or operated in the circuit system of the intelligent posture detection apparatus. The circuit system is, for example, an integrated circuit or firmware.

In one embodiment of the present disclosure, in the method for intelligent posture detection, an image-retrieval circuit of the circuit system is used to retrieve an image, and then an image processor is used to extract features of the image. An operating circuit operates an intelligence model to determine an object window that covers an object in the image according to the features of the image, and multiple key points of the object are defined. A first correlation among a whole or part of the multiple key points that are used to determine a current posture is established. A second correlation between the object window that covers the object in the current posture and the whole or part of the multiple key points is also established. Whether or not the object is currently in the poor posture can be determined according to the first correlation and/or the second correlation.

Further, the first correlation can be a positional relationship among the multiple key points of the object. For example, the first correlation can be at least one of a distance between any two of the key points, an included angle between a line connecting any two of the key points and a horizontal line, and a distance between the line connecting any two of the key points and a line connecting another two of the key points.

Further, the second correlation is a geometric relationship between a line connecting any two of the multiple key points and the object window (e.g., a distance between any of the key points and any side of the object window), or whether the line connecting any two of the key points is outside or inside the object window.

Thus, the circuit system determines whether the object is currently in the poor posture according to the first correlation and/or the second correlation, and any change of an aspect ratio of the object window can be cooperatively used to determine whether the object is currently in the poor posture.

Further, the circuit system presets multiple object classifications. Accordingly, the intelligence model relies on the features of the image to calculate a confidence in which the image belongs to one of the object classifications. The confidence is then compared with a confidence threshold, and the object window can be determined based on the image having the confidence that is larger than the confidence threshold. The multiple key points of the object covered by the object window can be determined after geometric information of the object window is obtained.

Further, in the process of calculating the confidence in which the image is a different object by the intelligence model, the intelligence model calculates a classification confidence in which the image is one of the object classifications and calculates an object confidence in which the image is a predefined object according to the features of the image. A confidence product is then obtained by multiplying the classification confidence by the object confidence, so that the object window and the multiple key points can be decided based on the image having the confidence product that is larger than the confidence threshold.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1A and FIG. 1B are schematic diagrams illustrating a circumstance in which an intelligent posture detection apparatus is installed;

FIG. 2 is a schematic diagram illustrating circuit components of the intelligent posture detection apparatus according to one embodiment of the present disclosure;

FIG. 3 is a schematic diagram illustrating a vision sensing convolutional neural network being used to define an object window in a method for intelligent posture detection according to one embodiment of the present disclosure;

FIG. 4 is a flowchart illustrating the method for intelligent posture detection according to one embodiment of the present disclosure;

FIG. 5 is a schematic diagram depicting a human face on which the object window is defined and multiple key points are determined according to one embodiment of the present disclosure;

FIG. 6 is a schematic diagram showing the face looking up according to one embodiment of the present disclosure;

FIG. 7 is a schematic diagram showing a hunched posture according to one embodiment of the present disclosure;

FIG. 8 is a schematic diagram showing a posture of unduly lowering a head according to one embodiment of the present disclosure;

FIG. 9 is a schematic diagram showing a posture of a hand supporting the sideways tilted head according to one embodiment of the present disclosure;

FIG. 10 is a schematic diagram showing a posture of turning the head by a large angle according to one embodiment of the present disclosure; and

FIG. 11 is a schematic diagram showing a posture of turning a human body by an overly large angle according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The present disclosure relates to a method for intelligent posture detection, an intelligent posture detection apparatus, and a circuit system. In an aspect, the method for intelligent posture detection can be implemented in the intelligent posture detection apparatus or the circuit system that can be operated in the intelligent posture detection apparatus. The circuit system is, for example, an integrated circuit (IC) or firmware.

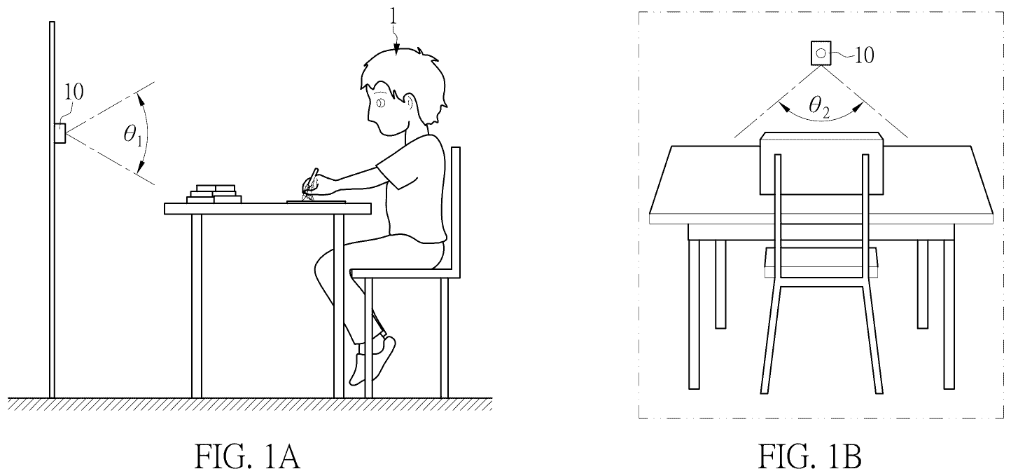

Reference is made to FIG. 1A and FIG. 1B, which are schematic diagrams showing a circumstance in which the intelligent posture detection apparatus is installed.

FIG. 1A shows an intelligent posture detection apparatus 10 that is disposed in front of a person 1. The intelligent posture detection apparatus 10 is disposed at a position having a certain distance from the person 1 based on imaging capability (e.g., an image resolution) and parameters (e.g., a lens focus) of a camera in the intelligent posture detection apparatus 10, so as to facilitate obtaining of an image of the person 1 or any specific object. In the present example, the camera of the intelligent posture detection apparatus 10 is capable of capturing the image within a vertical shooting angle θ₁ in a specific distance. The intelligent posture detection apparatus 10 shown in FIG. 1B is capable of capturing the image within a horizontal shooting angle θ₂.

It is worth mentioning that, in one of the embodiments of the present disclosure, the method for intelligent posture detection is suitably operated in a standalone device for a specific purpose, and has the advantage of low power consumption. For example, the device is a webcam or a standalone electronic device. In the method, a vision sensing technology is particularly used to retrieve a posture of a front object. A machine-learning algorithm is used to learn image features relating to the posture.

For example, in order to determine a posture of the person 1, the intelligent posture detection apparatus 10 can be implemented in a standalone device with a photographing function, and the device can be installed on a desk. The circuit system in the intelligent posture detection apparatus 10 can be used to capture images of an object in front of the device, so as to perform vision sensing, feature determination, and posture determination. For example, the method operated in the circuit system is used to determine whether a child or a teenager who sits in front of a desk is in a poor posture or whether a person who stands in front of a mirror is in a poor posture.

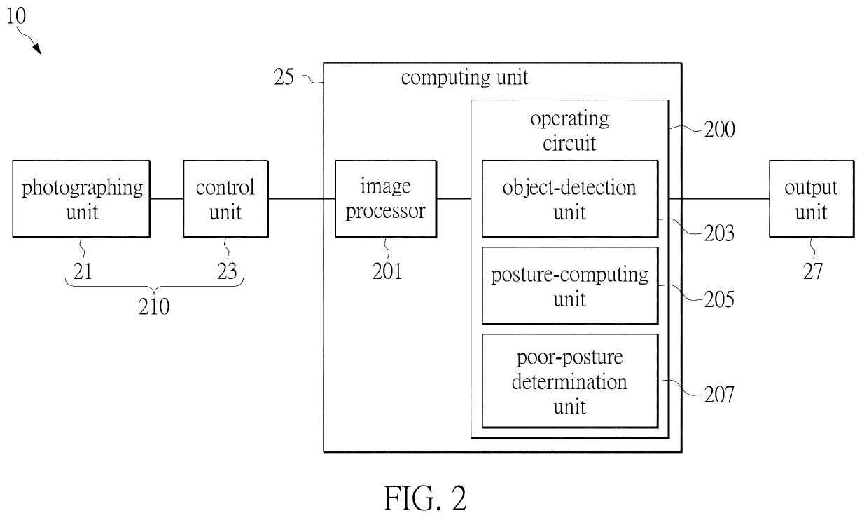

FIG. 2 is a schematic diagram of circuit components of the intelligent posture detection apparatus according to one embodiment of the present disclosure.

Main circuit components of the intelligent posture detection apparatus 10 include an image-retrieval circuit 210 that can be divided into a photographing unit 21 and a backend control unit 23. The photographing unit 21 is used to photograph an object within a shooting range that is defined by the vertical shooting angle θ₁ and the horizontal shooting angle θ₂. The main circuit components of the intelligent posture detection apparatus 10 also include a computing unit 25 that can functionally include an image processor 201 and an operating circuit 200. The operating circuit 200 can be the circuit system implemented by a central processing unit (CPU) or a microcontroller, and can be used for extracting image features from a received image and performing the method for intelligent posture detection based on the image features. The functions of the operating circuit 200 can be implemented by multiple software units.

The circuit system implemented by the operating circuit 200 is referred to, but not limited to, several software units shown in the FIG. 2. For example, an object-detection unit 203 can rely on multiple object classifications preset by the circuit system and the image features to determine the object in front of the intelligent posture detection apparatus 10. The object is, for example, a human face, an upper body of a person, or a full body of the person. The circuit system includes a posture-computing unit 205 that can determine an instant posture of the object according to a geometric relationship between the object window and the multiple key points defined by the circuit system. After that, a poor-posture determination unit 207 of the circuit system determines whether the object is in a poor posture according to the geometric relationship between the object window and the multiple key points and predefined thresholds provided by the circuit system.

Afterwards, based on various thresholds for the geometric relationships and a lasting-posture time threshold, the instant posture of the person can be determined. An output unit 27 of the intelligent posture detection apparatus 10 outputs a posture-determination result. According to one embodiment of the present disclosure, the intelligent posture detection apparatus 10 can provide various notifications (e.g., a sound or a text) for informing that the person is in one of the poor postures.

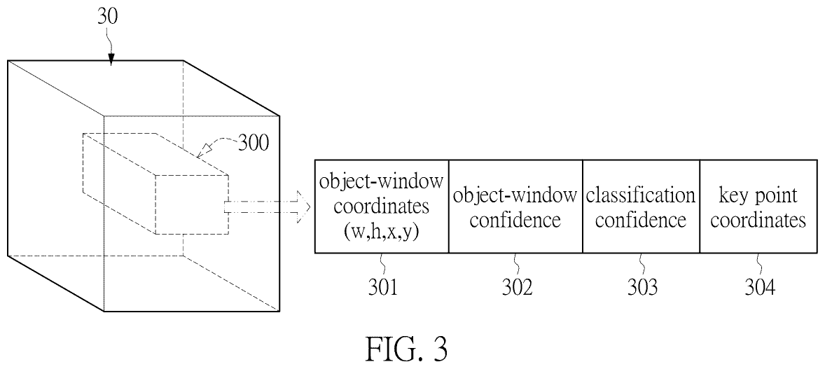

According to one of the embodiments of the circuit system that performs the method for intelligent posture detection, through an artificial intelligence technology, an object window that is used to determine a posture can be defined based on the image features. For the related calculation, reference can be made to FIG. 3, which is a schematic diagram illustrating a vision sensing convolution neural network being used to obtain the object window in the method for intelligent posture detection according to one embodiment of the present disclosure.

One of the objectives of the method for intelligent posture detection is to determine whether a person in front of the intelligent posture detection apparatus has the problem of a poor posture according to the image features of the upper body or the full body of the person. In one of the approaches that implement the method for intelligent posture detection, an intelligent model trained by a deep-learning neural network (such as a convolutional neural network (CNN)) is used to determine if the image includes an object that belongs to any of the object classifications (such as a human-like object, a human face, or a specific human organ) preset by the circuit system, and any predefined object with any posture to be determined by the circuit system. It should be noted that, in an aspect, the circuit system is configured to determine the posture of the person based on the image features of the upper body of the person.

According to the example shown in the diagram, in the circuit system, the image-retrieval circuit 210 described in the embodiment of FIG. 2 is used to retrieve an image, and then the image processor 201 extracts the features of the image. After that, the operating circuit 200 operates an intelligence model for firstly deciding a range (e.g., an object-window prediction range 30 outputted by the intelligence model). The circuit system calculates a confidence that the image is one of the object classifications preset by the circuit system based on the features of the image. The confidence is then compared with a confidence threshold, and an object window 30 can be decided based on the image whose confidence being larger than the confidence threshold. After geometric information (e.g., coordinates) of an object window 300 is obtained, multiple key points of a predefined object covered by the object window 300 can be determined.

According to the embodiment shown in the figure, a memory of the circuit system is configured to record the geometric information that is used to depict the object window 300 after the object window 300 is determined from the image. For example, the object window 300 can be depicted by object-window coordinates 301 that indicate the geometric information of the object window 300 by coordinates (x, y), a width (w), and a height (h). In the meantime, an object-window confidence 302 and a classification confidence 303 calculated by the intelligent model can be recorded in the memory. Furthermore, key point coordinates 304 that are set based on the predefined object and used for determining a posture are also recorded.

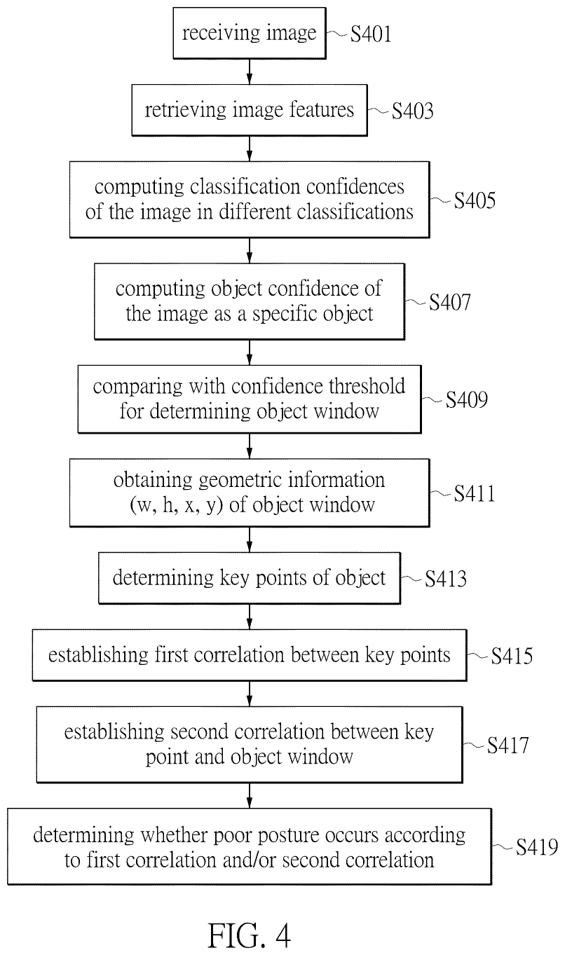

Based on the above-described technologies, reference is next made to FIG. 4, which is a flowchart illustrating the method for intelligent posture detection according to one embodiment of the present disclosure.

In the beginning, an image-retrieval circuit of the intelligent posture detection apparatus retrieves an image of an object in front of the apparatus (step S401). Through an image processor, image features are extracted (step S403), and an object window covering the object in the image and multiple key points used to determine a posture of the object can be decided based on the image features.

According to one embodiment of the present disclosure, the circuit system sets up various object classifications based on the requirements for determining postures of an object. Taking a person as an example, the object classifications can include an upper body, a full body, or a specific portion of the person. The circuit system can further set up a specific object used to determine the posture based on an instant requirement. For example, when determining a sitting posture of the person, the specific object can be the face and shoulders of the upper body of the person. Thus, the above-mentioned intelligent model (which is trained by the deep-learning neural network that applies a vision sensing technology) can calculate the probabilities of the image being the various object classifications based on the object classifications preset by the circuit system. The probabilities to be calculated are, for example, classification confidences that act as the confidences used to decide the object window in the image (step S405). Based on the instant requirement, a probability of the image being the predefined object can be calculated, and is an object confidence that is used to determine whether the object to be covered by the object window is sufficient to determine the posture of the person. Accordingly, the circuit system decides the object window (step S407).

That is to say, the method for intelligent posture detection is used to determine the object window that covers the object based on the confidence and a confidence threshold preset by the system, so as to determine a posture of the object. An object confidence and a classification confidence with respect to the object can be calculated based on the object classifications preset by the circuit system. The circuit system can rely on the classification confidence and the object confidence to decide the object window in the image. According to one of the embodiments of the present disclosure, the classification confidence is multiplied by the object confidence for obtaining a confidence product. Therefore, the object window can be decided based on the image having the confidence (e.g., the confidence product) that is larger than the confidence threshold (step S409).

After that, geometric information (w, h, x, y) of an object window can be obtained (step S411). An intelligence model obtained by training images is used to determine multiple key points of the object (step S413). Next, the multiple key points that are determined by a predefined object (which is provided for the circuit system to determine the posture) can be used to establish a first correlation among part or all of the key points of the object in a current posture in the image (step S415). According to one embodiment of the present disclosure, the first correlation is used to describe geometric relationships of the multiple key points. For example, a memory of the circuit system records coordinates of the multiple key points in an image that is currently retrieved. Here, a distance between two selected ones of the key points is calculated, an included angle between a line connecting any two of the key points and a horizontal line or a vertical line is calculated, and/or a distance between the line connecting any two of the key points and a line connecting another two of the key points is calculated.

A second correlation between the object window that is defined based on a current posture of the object in the image and part or all of the key points is established (step S417). In one embodiment of the present disclosure, the second correlation mainly describes a geometric relationship between the multiple key points and the object window. For example, a memory of the circuit system is used to record the geometric relationship between the key points and the object window. The second correlation is at least one of a distance between a line connecting any two of the key points and any side of the object window, or whether the line connecting any two key points is outside the object window or inside the object window.

Finally, any change of the first correlation and/or the second correlation can be used to determine whether the object is in a poor posture (step S419), and any change of an aspect ratio of the object window can be cooperatively used to determine if a current posture of the object is poor.

For example, the intelligent posture detection apparatus can be installed in front of a person to be photographed. The image-retrieval circuit retrieves instant images of the person. The image processor then extracts features of the images, and the intelligence model decides the object window and the key points correlated with the person based on the features of the image.

The exemplary examples that operate the method for intelligent posture detection are as follows. The object covered by the object window is an upper body of the person. The key points of the person are configured to recognize facial elevation angle, depression angle and turning direction of the person, and part of facial organs and/or shoulders of the person.

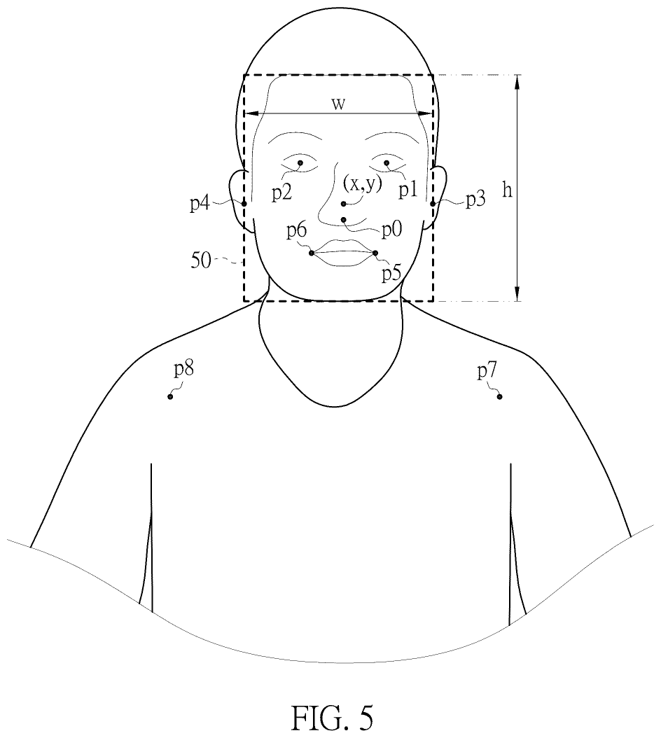

FIG. 5 is a schematic diagram showing an object window covering a human face and the related key points according to one embodiment of the present disclosure.

The diagram exemplarily shows that the key points are set on an upper body of the person. An object window 50 covering the facial features is decided by an intelligence model. The object window 50 is defined by an object-window width “w” and an object-window height “h.” Central coordinates of the object window 50 are depicted by a central horizontal coordinate of object window “x” and a central vertical coordinate of object window “y.”

The object window 50 can cover part of the facial organs that can be used to recognize the facial elevation angle, the depression angle, and the turning direction. The multiple key points are defined. For example, a key point p0 points to a center of the human face, e.g., a nasal tip. The key points can also point to centers of the eyes. For example, a key point p1 points to a left pupil, and a key point p2 points to a right pupil. Further, the key points can respectively point to a left ear and a right ear. For example, a key point p3 points to a center of gravity of the left ear, and a key point p4 points to a center of gravity of the right ear. Still further, the key points can point to two mouth corners. For example, a key point p5 points to a left mouth corner, and a key point p6 points to a right mouth corner. In addition, the key points can also point to two shoulders of an upper body of the person. For example, a key point p7 points to a left shoulder, and a key point p8 points to a right shoulder.

Thus, in the method for intelligent posture detection, the above-described object window and the key points (p0, p1, p2, p3, p4, p5, p6, p7, and p8) can be used to determine a posture of an upper body of the person. In particular, the first correlation is defined to illustrate geometric relationships of the multiple key points, and the second correlation is defined to illustrate geometric relationships between the multiple key points and the object window. The first correlation and the second correlation are referred to for determining whether the person is in a poor posture.

During determination of whether the object is in a poor posture, the object is determined to be in a poor posture when a distance of a line connecting two of the key points in the first correlation is smaller than a first distance threshold preset by the circuit system, is determined to be in the poor posture when an included angle between the line connecting the two of the key points in the first correlation and a horizontal line or a vertical line is larger than an angular threshold, or is determined to be in the poor posture when a distance between the line connecting the two of the key points in the first correlation and a line connecting another two of the key points is smaller than a second distance threshold. The object is also determined to be in the poor posture when a distance between a line connecting two of the key points in the second correlation and one of the sides of the object window is smaller than a third distance threshold, or is determined to be in the poor posture when a distance ratio of the line connecting the two of the key points in the second correlation to the one of the sides of the object window is smaller than a ratio threshold. Further, based on the second correlation in which the line connecting any two of the key points is outside or inside the object window, an actual change of the positions of the key points can be used to determine occurrence or non-occurrence of the poor posture.

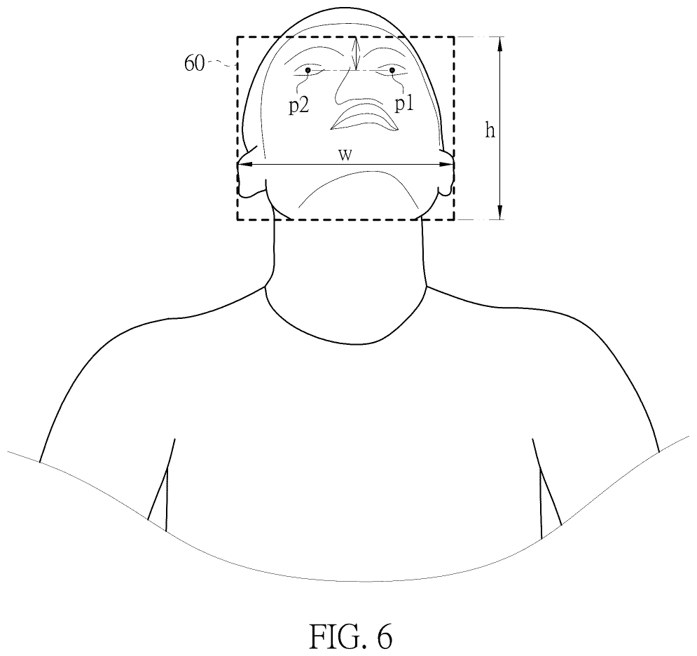

One of the exemplary examples is shown in FIG. 6, which is a schematic diagram showing a human face looking up.

In FIG. 6, from an image that is instantly obtained, an intelligence model is configured to determine an object window 60 that covers an object (i.e., a human face) in the image and has an object-window width “w” and an object-window height “h”. Further, the positions of the key point “p1” (i.e., the left pupil) and the key point “p2” (i.e., the right pupil) are obtained, so as to obtain a distance between a line connecting the key point “p1” and the key point “p2” and a top side of the object window 60. The posture can be determined to be a poor posture if the distance is changed to be larger than a predetermined distance.

In the present example, a line is formed between the key point “p1” (i.e., the left pupil) and the key point “p2” (i.e., the right pupil). A human head is determined to be reclined back if the distance between the line and the top side of the object window 60 is changed to be smaller than the third distance threshold defined by the circuit system. Further, if the posture is maintained for a predetermined time threshold, the circuit system determines that the human head is in a poor posture and can issue a warning message. Referring to Equation 1, the third distance threshold can be set as a ratio of a distance that is defined between a midpoint of the line connecting the key point “p1” and the key point “p2” and the top side of the object window 60 to the object-window height “h”. The present example shows that the third distance threshold is 30%. The human face is determined to be looking up if the ratio that is instantly calculated is smaller than 30%.

In Equation 1, “yp1” and “yp2” are horizontal coordinates of the key point p1 and the key point p2, “y1” represents horizontal coordinates of a top side of the object window, and “h” represents the object-window height.

$$\frac{[ ( {y}_{{p}_{1}} + {y}_{{p}_{2}} ) / 2 - {y}_{1} ]}{h} < 0.3 . \qquad Equation 1$$

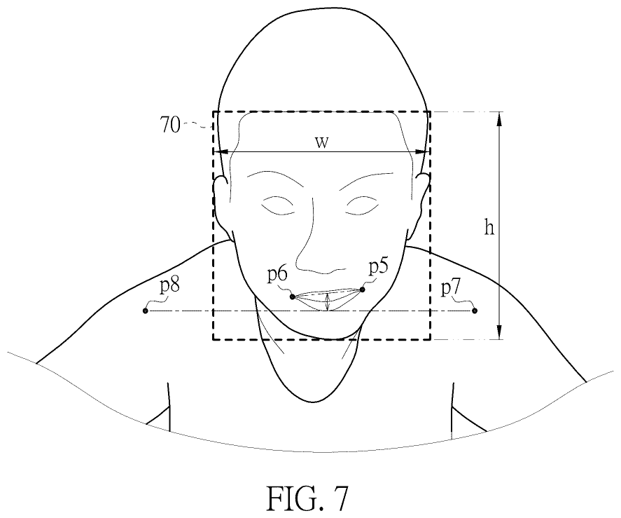

One further example is shown in FIG. 7, which is a schematic diagram showing a hunched posture.

FIG. 7 shows that the circuit system determines an object window 70 defined by an object-window width “w” and an object-window height “h”. Here, a line connecting the key point p5 (i.e., the left mouth corner) and the key point P6 (i.e., the right mouth corner) is formed, a line connecting the key point p7 (i.e., the left shoulder) and the key point p8 (i.e., the right shoulder) is also formed, and a distance between two midpoints of the above-mentioned two lines is smaller than the second distance threshold. As shown in Equation 2, “((yₚ_{₇}+yₚ_{₈})−(yₚ_{₅}+yₚ_{₆}))/2” is used to calculate an absolute distance between the midpoints of the two lines. This absolute distance is divided by the object-window height “h” for conversion into a relative distance. The above-mentioned second distance threshold is, for example, a ratio (“40%”) of the distance between the two midpoints of the two lines to the object-window height “h”. If the ratio calculated in the Equation 2 is smaller than the second distance threshold (“40%”), the hunched posture is determined.

$$\frac{[ ( {y}_{{p}_{7}} + {y}_{{p}_{8}} ) - ( {y}_{{p}_{5}} + {y}_{{p}_{6}} ) ]}{2 h} < 0.4 . \qquad Equation 2$$

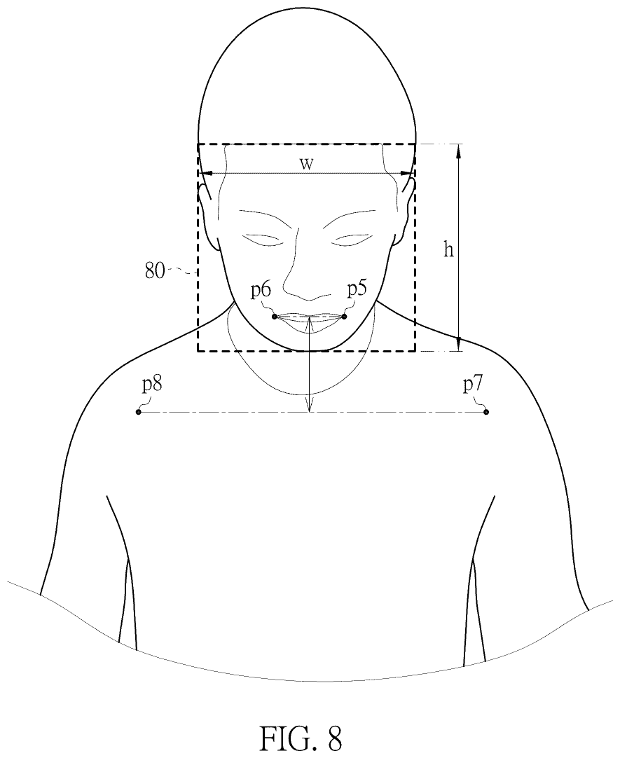

Another example is shown in FIG. 8, which is a schematic diagram showing unduly lowering of the head.

FIG. 8 shows that a line between the key point p5 (i.e., the left mouth corner) and the key point p6 (i.e., the right mouth corner) is formed within an object window 80, and a line between the key point p7 (i.e., the left shoulder) and the key point p8 (i.e., the right shoulder) is also formed within the object window 80. As shown in Equation 3, a ratio of a distance between the two midpoints of the two lines to the object-window height “h” is calculated and compared with the second distance threshold, e.g., “40%”. If the ratio is smaller than 40%, unduly lowering of the head is determined.

$$\frac{[ ( {y}_{{p}_{7}} + {y}_{{p}_{8}} ) - ( {y}_{{p}_{5}} + {y}_{{p}_{6}} ) ]}{2 h} < 0.4 . \qquad Equation 3$$

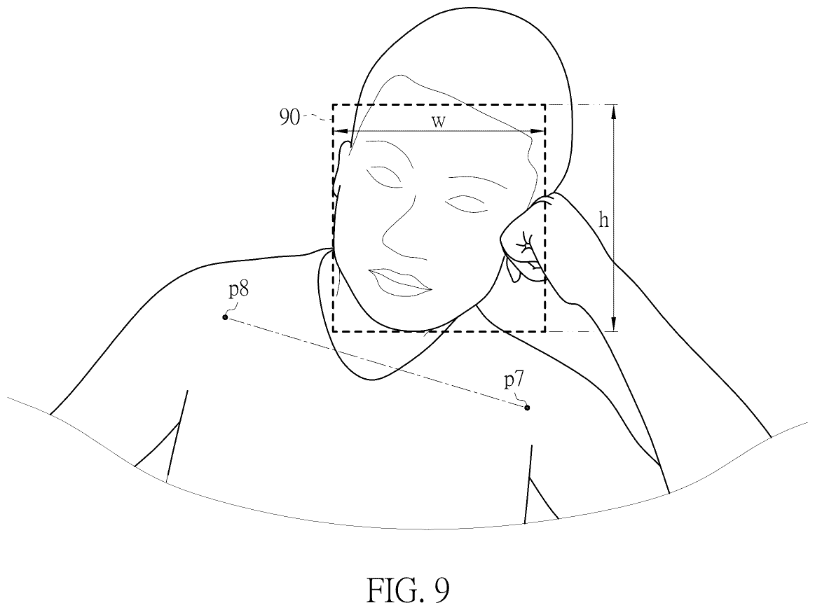

FIG. 9 is a schematic diagram showing an exemplary example of a posture of a hand supporting the sideways tilted head.

FIG. 9 shows a slope between the key point p7 (i.e., the left shoulder) and the key point p8 (i.e., the right shoulder). If the slope (e.g., an included angle based on a horizontal line or a vertical line) is larger than a threshold (e.g., an angular threshold) preset by the circuit system, and this status lasts for a period of time, a poor posture is determined. As shown in Equation 4, the angular threshold is set to be 15 degrees. If the slope (i.e., a ratio of a y-axis distance (yₚ_{₇}−yₚ_{₈}) to an x-axis distance (xₚ_{₇}−xₚ_{₈})) between the key point p7 and the key point p8 is larger than 15 degrees, and this status lasts for a period of time, a posture of the hand supporting the sideways tilted head is determined.

$${tan}^{- 1} ( \frac{{y}_{{p}_{7}} - {y}_{{p}_{8}}}{{x}_{{p}_{7}} - {x}_{{p}_{8}}} ) < {15}^{∘} . \qquad Equation 4$$

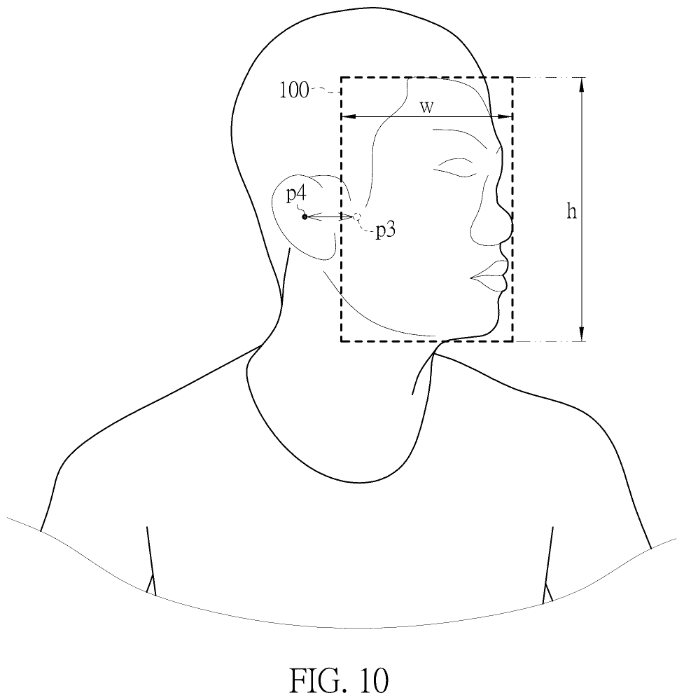

FIG. 10 is a schematic diagram showing an exemplary example of a posture of turning the head by a large angle.

FIG. 10 shows that an object window 100 is defined by an object-window width “w” and an object-window height “h” according to facial features. A ratio threshold can be defined by referring to a ratio of a distance between the key point p3 (i.e., the center of gravity of the left ear) and the key point p4 (i.e., the center of gravity of the right ear) to the object-window width “w” of the object window 100. If the ratio of the distance between the key point p3 and the key point p4 to the object-window width “w” is smaller than the ratio threshold, and this status lasts for a period of time, a poor posture is determined. As shown in Equation 5, the ratio threshold can be set to be 40%. If the ratio of the distance between the key point p3 and the key point p4 to the object-window width “w” is smaller than 40%, and this status lasts for a period of time, a posture of turning the head by a large angle is determined.

$$\frac{{x}_{{p}_{3}} - {x}_{{p}_{4}}}{w} < 0.4 . \qquad Equation 5$$

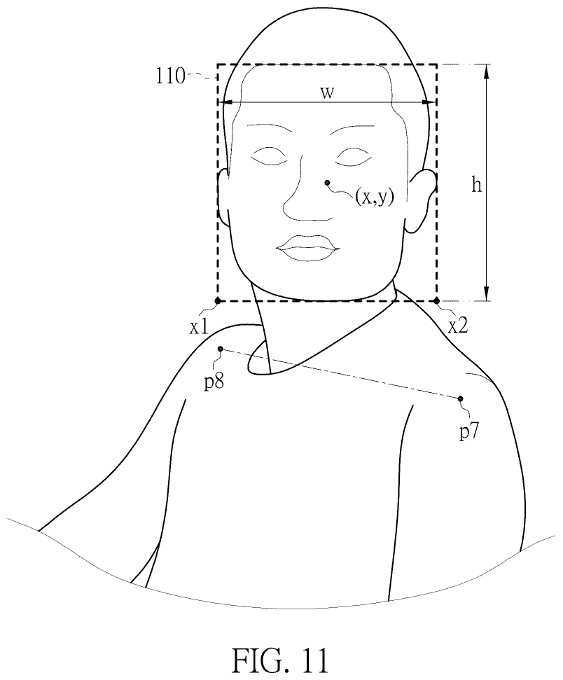

Next example is shown in FIG. 11, which shows a posture of turning a human body by an overly large angle.

FIG. 11 shows an object window 110. Geometric relationships among two lower ends (such as a first end x1 and a second end x2 of the object window 110), the key point p7 (i.e., the left shoulder), and the key point p8 (i.e., the right shoulder) are used to determine whether an object covered by the object window 110 is in a poor posture. As shown in Equation 6, “x1” is defined to be equal to an x-axis coordinate subtracting 0.5 times the object-window width “w”, and “x2” is defined to be equal to the x-axis coordinate adding 0.5 times the object-window width “w”. If the x-axis coordinate of the key point p7 is between “x1” and “x2”, or the x-axis coordinate of the key point p8 is between “x1” and “x2”, the object window 110 has a specific aspect ratio (i.e., an aspect ratio of an abnormal posture). When this status lasts for a period of time, a posture of turning the human body by a specific angle is determined.

$$( \begin{matrix}{x}_{1} < {x}_{{p}_{7}} < {x}_{2} or {x}_{1} < {x}_{{p}_{8}} < {x}_{2} \\ {x}_{1} = x - 0.5 w \\ {x}_{2} = x + 0.5 w\end{matrix} ) . \qquad Equation 6$$

In conclusion, according to the above embodiments of the method for intelligent posture detection, the apparatus, and the circuit system, a deep-learning neural network uses a visual sensing method to obtain the object window and the multiple key points. An intelligence model is used to calculate a classification confidence of the object window in the image, and the object window that is able to determine the posture can be decided after comparison with the confidence threshold. An object confidence can also be calculated for determining a probability that the image covered by the object window is a human face. Accordingly, the object window can be affirmed, and the multiple key points used to determine the posture can be decided. Furthermore, various equations for determining the various poor postures are provided for using the geometric relationships of the key points to establish a first correlation, or using the geometric information between the key points and the object window to establish a second correlation. An aspect ratio of the object window can also be used. Based on the above ratios, changes of the distances, geometric relationships there-between, and the aspect ratio of the object windows, the problem of poor posture can be determined.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for intelligent posture detection, which is performed in a circuit system, the method comprising:
receiving an image;
determining an object window that covers an object in the image according to features of the image, and determining multiple key points of the object;
establishing a first correlation among a whole or part of the key points of the object in a current posture;
establishing a second correlation between the object window and the whole or part of the key points of the object in the current posture; and
determining the current posture of the object according to at least one of the first correlation or the second correlation.

2. The method according to claim 1, wherein the first correlation is at least one of a distance between any two of the key points, an included angle between a line connecting any two of the key points and a horizontal line, or a distance between the line connecting any two of the key points and a line connecting another two of the key points.

3. The method according to claim 2, wherein the second correlation is at least one of a distance between a line connecting any two of the key points and any one of sides of the object window or a determination of whether the line connecting any two of the key points is outside or inside the object window.

4. The method according to claim 3, wherein the circuit system determines whether the object is currently in a poor posture according to the first correlation and/or the second correlation, and any change of an aspect ratio of the object window is cooperatively used to determine whether the object is currently in the poor posture.

5. The method according to claim 4, wherein, in the image, the object is determined to be in the poor posture when a distance of a line connecting two of the key points in the first correlation is smaller than a first distance threshold, is determined to be in the poor posture when a distance between the line connecting the two of the key points in the first correlation and a line connecting another two of the key points is smaller than a second distance threshold, or is determined to be in the poor posture when an included angle between the line connecting the two of the key points in the first correlation and the horizontal line or a vertical line is larger than an angular threshold.

6. The method according to claim 4, wherein, in the image, the object is determined to be in the poor posture when a distance between a line connecting two of the key points in the second correlation and one of the sides of the object window is smaller than a third distance threshold, or is determined to be in the poor posture when a distance ratio of the line connecting the two of the key points to the one of the sides of the object window is smaller than a ratio threshold.

7. The method according to claim 1, wherein the circuit system is installed in an intelligent posture detection apparatus, and the intelligent posture detection apparatus is disposed in front of the object to be photographed; wherein an image-retrieval circuit of the intelligent posture detection apparatus is used to retrieve the image of the object, an image processor is used to extract features of the image, and an operating circuit is used to operate an intelligence model, so as to determine the object window and the multiple key points of the object according to the features of the image.

8. The method according to claim 7, wherein multiple object classifications are preset for the circuit system; wherein the intelligence model relies on the features of the image to calculate a confidence in which the image is a different object, compares the confidence with a confidence threshold, and determines the object window based on the image having the confidence that is larger than the confidence threshold; wherein the multiple key points of the object covered by the object window are determined after geometric information of the object window is obtained.

9. The method according to claim 8, wherein, in the process of calculating the confidence in which the image is the different object, the intelligence model calculates a classification confidence in which the image is one of the object classifications and calculates an object confidence in which the image is a predefined object according to the features of the image; wherein a confidence product is obtained by multiplying the classification confidence by the object confidence, and the object window and the multiple key points are determined by referring to the image having the confidence product that is larger than the confidence threshold.

10. A circuit system, characterized in that the circuit system performs the method as claimed in claim 1.

11. The circuit system according to claim 10, wherein the image is retrieved by an image-retrieval circuit, an image processor extracts features of the image, and an operating circuit operates an intelligence model for deciding the object window that covers the object in the image and the multiple key points of the object according to the features of the image.

12. The circuit system according to claim 11, wherein the circuit system presets multiple object classifications, and the intelligence model calculates a classification confidence in which the image is one of the object classifications and calculates an object confidence in which the image is a predefined object according to the features of the image; wherein a confidence product is obtained by multiplying the classification confidence by the object confidence, and the object window is decided from the image having the confidence product that is larger than a confidence threshold; wherein the multiple key points of the object covered by the object window are determined after geometric information of the object window is obtained.

13. An intelligent posture detection apparatus, comprising:
a circuit system, wherein the circuit system operates a method for intelligent posture detection, and the method includes:
receiving an image from an image-retrieval circuit;
extracting features of the image by an image processor;
operating an intelligence model by an operating circuit for determining an object window that covers an object in the image according the features of the image, and determining multiple key points of the object;
establishing a first correlation among a whole or part of the key points of the object in a current posture;
establishing a second correlation between the object window and the whole or part of the key points of the object in the current posture; and
determining the current posture of the object according to at least one of the first correlation or the second correlation.

14. The intelligent posture detection apparatus according to claim 13, wherein the intelligent posture detection apparatus is installed in front of a person to be photographed, the image-retrieval circuit captures the image of the person, the image processor extracts the features of the image, and the intelligence model relies on the features of the image to decide the object window and multiple key points of the person.

15. The intelligent posture detection apparatus according to claim 14, wherein the object covered by the object window is an upper body of the person, and the key points of the person are configured to recognize a facial elevation angle, a depression angle, and a turning direction of the person, and part of facial organs and/or shoulders of the person.

16. The intelligent posture detection apparatus according to claim 13, wherein, in the method, the first correlation is at least one of a distance between any two of the key points, an included angle between a line connecting any two of the key points and a horizontal line, or a distance between the line connecting any two of the key points and a line connecting another two of the key points.

17. The intelligent posture detection apparatus according to claim 16, wherein, in the method, the second correlation is at least one of a distance between a line connecting any two of the key points and any one of sides of the object window or a determination of whether the line connecting any two of the key points is outside or inside the object window.

18. The intelligent posture detection apparatus according to claim 17, wherein, in the method, the circuit system determines whether the object is currently in a poor posture according to the first correlation and/or the second correlation, and any change of an aspect ratio of the object window is cooperatively used to determine whether the object is currently in the poor posture.

19. The intelligent posture detection apparatus according to claim 13, wherein the circuit system presets multiple object classifications; wherein the intelligence model relies on the features of the image to calculate a confidence in which the image is a different object, compares the confidence with a confidence threshold, and determines the object window based on the image having the confidence that is larger than the confidence threshold; wherein the multiple key points of the object covered by the object window are determined after geometric information of the object window is obtained.

20. The intelligent posture detection apparatus according to claim 19, wherein, in the process of calculating the confidence in which the image is the different object, the intelligence model calculates a classification confidence in which the image is one of the object classifications and calculates an object confidence in which the image is a predefined object according to the features of the image; wherein a confidence product is obtained by multiplying the classification confidence by the object confidence, and the object window and the multiple key points are determined by referring to the image having the confidence product that is larger than the confidence threshold.
